(19) United States
(12) Patent Application Publication
(10) Pub. No.: US 2025/0013396 A1
(43) Pub. Date: Jan. 9, 2025

(54) PRINTING SYSTEM, PRINT CONTROL APPARATUS, PRINT CONTROL METHOD, AND NON-TRANSITORY RECORDING MEDIUM

(71) Applicants: Takumi SAKAGAMI, Tokyo (JP); Ayano NAKAMURA, Tokyo (JP); Tadao SATO, Tokyo (JP); Hidenori KINOSHITA, Tokyo (JP)

(72) Inventors: Takumi SAKAGAMI, Tokyo (JP); Ayano NAKAMURA, Tokyo (JP); Tadao SATO, Tokyo (JP); Hidenori KINOSHITA, Tokyo (JP)

(21) Appl. No.: 18/760,088

(22) Filed: Jul. 1, 2024

(30) Foreign Application Priority Data
Jul. 6, 2023 (JP) 2023-111534

(51) Int. Cl. G06F 3/12

(52) U.S. Cl. CPC G06F 3/1204; G06F 3/1217; G06F 3/1237; G06F 3/1285

(57) ABSTRACT

A printing system includes an image forming apparatus and a print control apparatus including circuitry. The circuitry is to identify, from among a plurality of pages of first content data input to the print control apparatus, one or more pages having contents that are changed from second content data, the second content data being printed by the image forming apparatus, and cause the image forming apparatus to print the one or more pages having the changed contents by a number of printed copies of the second content data, and the first content data by a number of remaining copies out of a number of copies to be printed set for the second content data.

### CROSS-REFERENCE TO RELATED APPLICATIONS

This patent application is based on and claims priority pursuant to 35 U.S.C. § 119(a) to Japanese Patent Application No. 2023-111534, filed on Jul. 6, 2023, in the Japan Patent Office, the entire disclosure of which is hereby incorporated by reference herein.

### BACKGROUND

### Technical Field

The present disclosure relates to a printing system, a print control apparatus, a print control method, and a non-transitory recording medium.

### Related Art

As known in the art, various contents such as documents and catalogs are output (printed) as printed matters in any printing environment including an office, a printing factory, or an individual. It is assumed that a content of a document is changed while a user is printing the document. In such a case, the user needs to interrupt the printing and reprint the document, which is extremely time-consuming, especially when a large volume of a document is being printed. For the purpose of reducing the time and effort of the user, various efforts have been made in the related art. As one example, a technique for implementing a function of “difference printing” is known. When the difference printing is designated for a document that is scheduled to be updated, object data in a format of a page description language (PDL) generated by a printer driver is retained. When the updated document is printed, data including only one or more pages whose data contents are changed is transmitted to a printer so that the difference printing is executed.

### SUMMARY

In one aspect, a printing system includes an image forming apparatus and a print control apparatus including circuitry. The circuitry is to identify, from among a plurality of pages of first content data input to the print control apparatus, one or more pages having contents that are changed from second content data, the second content data being printed by the image forming apparatus, and cause the image forming apparatus to print the one or more pages having the changed contents by a number of printed copies of the second content data, and the first content data by a number of remaining copies out of a number of copies to be printed set for the second content data.

In another aspect, a print control apparatus for controlling printing executed by an image forming apparatus includes circuitry. The circuitry is to identify, from among a plurality of pages of first content data input to the print control apparatus, one or more pages having contents that are changed from second content data, the second content data being printed by the image forming apparatus, and cause the image forming apparatus to print the one or more pages having the changed contents by a number of printed copies of the second content data, and the first content data by a number of remaining copies out of a number of copies to be printed set for the second content data.

In another aspect, a print control method performed by a print control apparatus includes identifying, from among a plurality of pages of first content data input to the print control apparatus, one or more pages having contents that are changed from second content data, the second content data being printed by an image forming apparatus, and causing the image forming apparatus to print the one or more pages having the changed contents by a number of printed copies of the second content data, and the first content data by a number of remaining copies out of a number of copies to be printed set for the second content data.

In another aspect, a non-transitory recording medium stores a plurality of program codes which, when executed by one or more processors of a print control apparatus, causes the one or more processors to perform the print control method including identifying, from among a plurality of pages of first content data input to the print control apparatus, one or more pages having contents that are changed from second content data, the second content data being printed by an image forming apparatus, and causing the image forming apparatus to print the one or more pages having the changed contents by a number of printed copies of the second content data, and the first content data by a number of remaining copies out of a number of copies to be printed set for the second content data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a printing system according to an embodiment of the present disclosure;

FIG. 2 is a schematic diagram illustrating operations performed by a printing system according to the embodiment of the present disclosure;

FIG. 3A is a block diagram illustrating a hardware configuration of an image forming apparatus according to the embodiment of the present disclosure;

FIG. 3B is a block diagram illustrating another hardware configuration of an image forming apparatus according to the embodiment of the present disclosure;

FIG. 4 is a block diagram illustrating a hardware configuration of a management server according to the embodiment of the present disclosure;

FIG. 5 is a block diagram illustrating a functional configuration of a management server according to the embodiment of the present disclosure;

FIG. 6 is the first flowchart of the processing executed by a management server according to the embodiment of the present disclosure;

FIG. 7 is the second flowchart of the processing executed by a management server according to the embodiment of the present disclosure;

FIG. 8 is the third flowchart of the processing executed by a management server according to the embodiment of the present disclosure;

FIG. 9 is a diagram illustrating an example of a separator according to the embodiment of the present disclosure; and

FIG. 10 is a diagram illustrating display of a screen for requesting an interruption according to the embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

It is assumed that content is updated during the printing of multiple copies of the content (document). According to the technique in the related art, the printing needs to be interrupted to print a page for replacing a corresponding page of the printed matter that has already been printed, and then the printing of the updated content by the number of remaining copies is resumed. As described above, according to the technique in the related art, when the content is updated during the printing, an operator needs to perform operations to interrupt and resume the printing. As a result, the complicated work procedures due to the above-mentioned background are not eliminated.

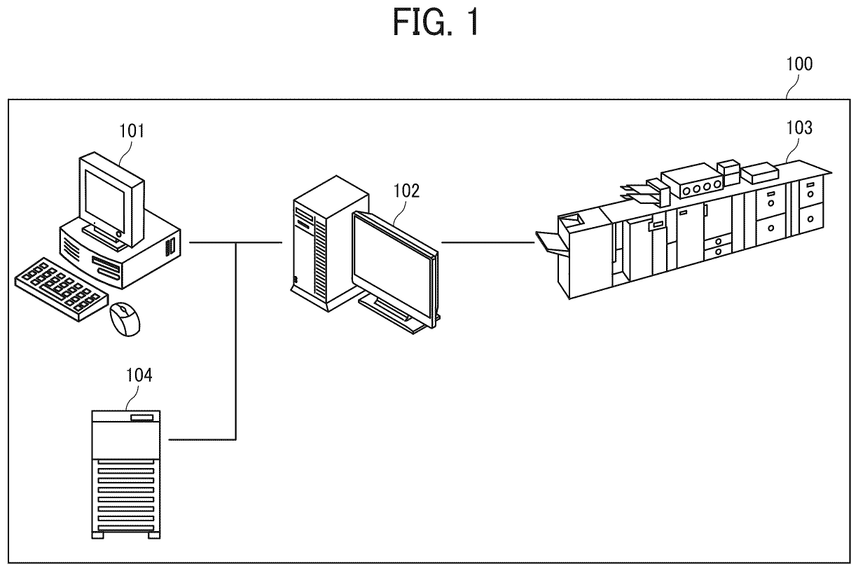

Embodiments of the present disclosure are described below with reference to the drawings. FIG. 1 is a schematic diagram illustrating a configuration of a printing system 100 according to an embodiment of the present disclosure.

The printing system 100 according to the present embodiment includes a client personal computer (client PC) 101, a digital front end (DFE) 102, an image forming apparatus 103, and a management server 104.

The client PC 101 creates a print job that an operator desires to be executed, and transmits the print job to the DFE 102 or the management server 104. The client PC 101 includes a display device that is a liquid crystal display and an input device such as a mouse, a keyboard, or both.

The print job is a set of electronic files relating to a print request that the client PC 101 transmits to the DFE 102 or the management server 104. For example, a print job includes content data (electronic data) subjected to printing and print setting information indicating printing conditions under which an image of the content data is printed. In the following description, the print setting information is referred to as printing conditions, and any one of the printing conditions is referred to as a printing condition.

The print job may include print data obtained by converting the content data into a format, such as a page description language (PDL), printable by the image forming apparatus 103 in accordance with the printing conditions.

The content data may be document data or image data. The printing conditions include various information relating to printing of texts or images based on the content data, such as the number of copies to be printed, a sheet size, printing in color, double-sided printing, and stapling. For the descriptive purposes, printing of texts or images based on the content data may be referred to as printing of the content data.

The DFE 102 receives the print job from the client PC 101 or the management server 104, generates drawing data with a raster image processor (RIP) engine based on the received print job, and transmits the drawing data to the image forming apparatus 103.

The image forming apparatus 103 executes an image forming operation based on the drawing data received from the DFE 102. In other words, the image forming apparatus 103 executes the print job. The image forming apparatus 103 is an image forming apparatus primarily intended for commercial printing. The image forming apparatus 103 may be, for example, an electrophotographic apparatus, an ink jet machine (liquid discharge apparatus), an offset machine, or a multifunction peripheral. The term “commercial printing” refers to a business field in which printing companies or print shops print and provide printed matters as products upon receiving orders and payments from clients. Examples of the printed matters as the products include advertisements, direct mail, posters, pamphlets, and books.

The management server 104 is an example of a print control apparatus, and manages the print job received from the client PC 101. In addition, the management server 104 transmits the print job to the DFE 102 in response to a request from the DFE 102.

In FIG. 1, the management server 104 is implemented by a single information processing apparatus, but is not limited to such a configuration. The management server 104 may be implemented by a plurality of information processing apparatuses.

The printing system 100 may not include the client PC 101. In the present embodiment, the image forming apparatus 103 may be a typical multifunction peripheral. In such a case, the printing system 100 only needs to include the client PC 101 having the functions of the management server 104 and the image forming apparatus 103.

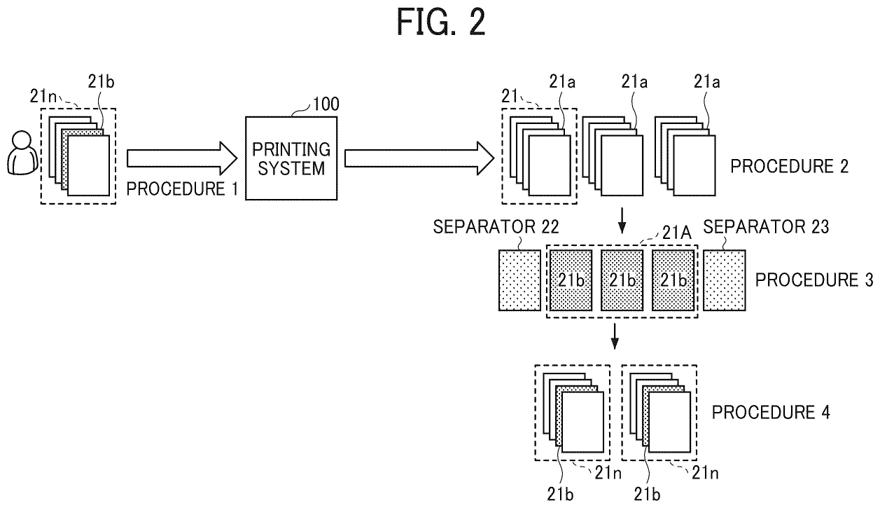

Next, with reference to FIG. 2, an overview of the operations performed by the printing system 100 according to the present embodiment is described. FIG. 2 is a schematic diagram illustrating the operations performed by the printing system 100 according to the embodiment of the present disclosure.

In FIG. 2, a case is illustrated, in which a multiple number of copies to be printed is set as a printing condition and content data is updated by the operator during the printing of the content data by the image forming apparatus 103. In this case, the printing system 100 performs the following procedures 1 to 4.

Procedure 1: An update of content data included in a print job being executed is detected and a page changed by the update is identified.

Procedure 2: The printing of the content data being executed by the image forming apparatus 103 is interrupted.

Procedure 3: The number of copies of a printed matter that have already been printed is obtained, and another printed matter (referred to as a replacement printed matter in the following description) for replacing a changed page of the printed matter already printed and separators before and after the replacement printed matter are printed. At this time, the replacement printed matter is printed by the number of copies of the printed matter already printed.

Procedure 4: The number of copies of the printed matter that have not yet been printed out of the number of copies to be printed set as the printing condition is obtained, and the content data after the update is printed by the number of copies of the printed matter that have not yet been printed.

The operations of the printing system 100 are described below in more detail. In FIG. 2, a case is illustrated, in which the management server 104 receives, from the client PC 101, a print job including a content data 21 and a printing condition in which the number of copies to be printed is set to five.

In the present embodiment, it is assumed that the content data 21 is updated to a content data 21n by the client PC 101 operated by the operator when the printing of up to three copies of the content data 21 is completed. In other words, the content data 21n in FIG. 2 is content data in which a page 21a included in the content data 21 is changed to a page 21b.

At this time, in the printing system 100, as the procedure 1, the management server 104 detects that the content data 21 included in the print job being executed is updated to the content data 21n and identifies a page that is the changed part in the content data 21. In the following description of the present embodiment, a change in the content data or the printing conditions included in a print job is referred to as an update of the print job. In the present embodiment, the content data 21n is an example of the first content data, and the content data 21 is an example of the second content data.

Next, as the procedure 2, the printing system 100 causes the management server 104 to interrupt the printing of the content data 21 being executed by the image forming apparatus 103.

Next, as the procedure 3, at the printing system 100, the management server 104 obtains the number of copies of the printed matter that have already been printed, which is “three copies,” from the image forming apparatus 103. The management server 104 causes the image forming apparatus 103 to print, as a replacement printed matter 21A for replacing the printed matter corresponding to the page 21a, three copies, which is the number of printed copies, of another printed matter corresponding to the page 21b. At this time, the management server 104 causes the image forming apparatus 103 to print a separator 22 and a separator 23 immediately before printing the replacement printed matter 21A and immediately after printing the replacement printed matter 21A, respectively. The separator 22 is an example of the first separator, and the separator 23 is an example of the second separator.

Accordingly, the printed matters printed by the image forming apparatus 103 in the procedure 3 are the separator 22, the replacement printed matter 21A for replacing the number of copies of the printed matter that have already been printed, and the separator 23.

The separator 22 is a printed matter indicating that the printed matter to be printed next is a replacement printed matter for replacing the printed matter of the content data 21 printed already. On the separator 22, information indicating that the printed matter to be printed next is a replacement printed matter may be printed.

The separator 23 is a printed matter indicating that the printed matter to be printed next is a printed matter on which the content data 21n after the update is printed. On the separator 23, information indicating that the printed matter to be printed next is a printed matter on which the content data after the update is printed may be printed.

Next, as the procedure 4, the printing system 100 obtains the number of copies of the printed matter that have not yet been printed, which is “two copies,” from the image forming apparatus 103 by the management server 104. The management server 104 causes the image forming apparatus 103 to print two copies of the content data 21n after the update.

In the present embodiment, as described above, when the content data being printed is updated, the operations of the interruption of printing, the printing of the replacement printed matter, and the printing of the number of copies of the printed matter that have not yet been printed of the content data after the update are automatically performed. As a result, according to the present embodiment, the operations by the operator to interrupt and restart the printing are not required. Thus, the time required for the operations to be performed by the operator is eliminated. In addition, in the present embodiment, since the operator does not have to operate the image forming apparatus 103, the time during which the printing executed by the image forming apparatus 103 is interrupted is shortened.

Accordingly, when the present embodiment is applied to the commercial printing, the present embodiment is useful because the time during which the printing executed by a commercial printing machine in a printing factory is interrupted is shortened.

According to the present embodiment, when the procedures 1 to 4 are completed, in the finisher of the image forming apparatus 103, the printed matter (three copies) on which the content data 21 is printed, the separator 22, the replacement printed matter 21A, the separator 23, and the printed matter (two copies) on which the content data 21n is printed are stacked.

The replacement printed matter 21A is manually replaced with each of the copies of the printed matter corresponding to the page 21a of the printed matter on which the content data 21 is printed.

At this time, according to the present embodiment, the separators 22 and 23 are inserted before and after the replacement printed matter 21A, respectively. Thus, the replacement printed matter 21A is easily identified from among the copies of the printed matter stacked on the finisher and the replacement printed matter 21A is easily taken out. As a result, the work for the replacement of the printed matter is facilitated.

Accordingly, when the present embodiment is applied to the commercial printing, the present embodiment is useful because the work for preparing a printed matter as a product to be provided to a print order requester is simplified after the completion of the printing executed by a commercial printing machine in a printing factory.

As described above, according to the present embodiment, the procedures for the work when the content (data) is updated is simplified, and the efficiency of the work increases.

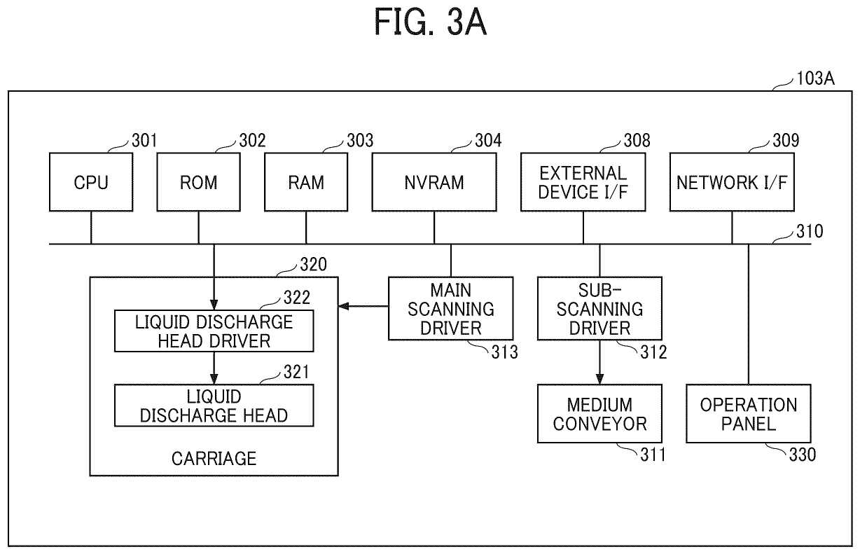

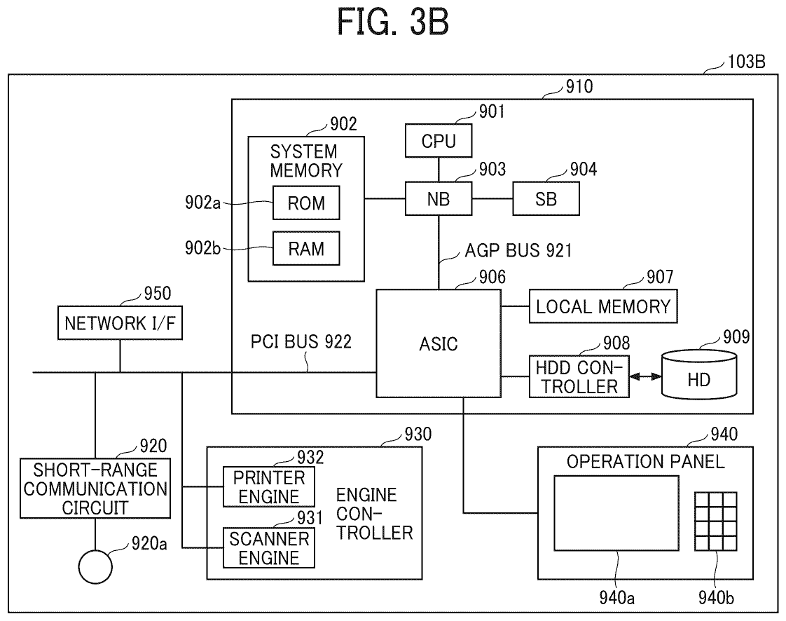

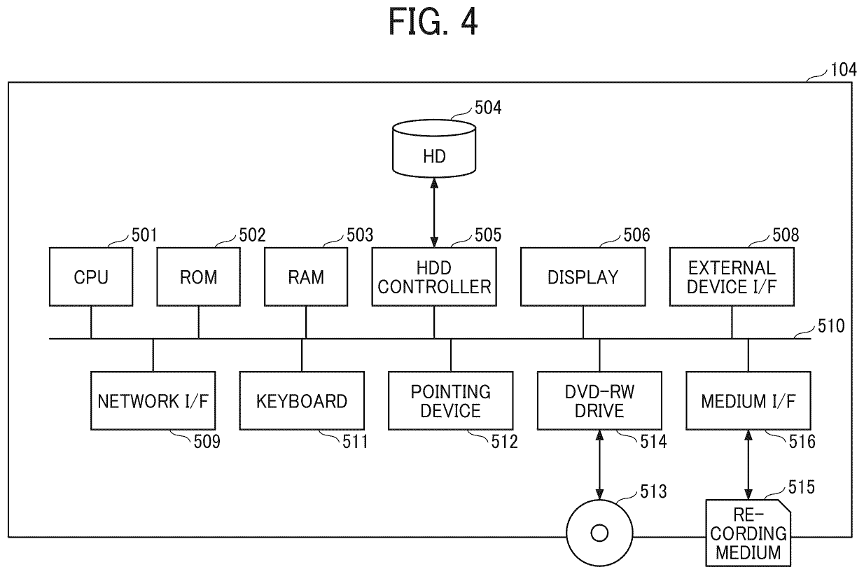

With reference to FIGS. 3A, 3B, and 4, the hardware configurations of the image forming apparatus 103 and the management server 104 included in the printing system 100 according to the present embodiment are described below.

FIG. 3A is a block diagram illustrating a hardware configuration of the image forming apparatus 103 according to the embodiment of the present disclosure. In FIG. 3A, a hardware configuration in the case where the image forming apparatus 103 is an inkjet machine (liquid discharge apparatus) 103A is illustrated.

As illustrated in FIG. 3A, the liquid discharge apparatus 103A includes a central processing unit (CPU) 301, a read-only memory (ROM) 302, a random-access memory (RAM) 303, a non-volatile random-access memory (NVRAM) 304, an external device interface (I/F) 308, a network I/F 309, and a bus line 310. In addition, the liquid discharge apparatus 103A includes a medium conveyor 311, a sub-scanning driver 312, a main scanning driver 313, a carriage 320, and an operation panel 330. The carriage 320 includes a liquid discharge head 321 and a liquid discharge head driver 322.

The CPU 301 controls the entire operation of the liquid discharge apparatus 103A. The ROM 302 stores a program such as an initial program loader (IPL) to boot the CPU 301. The RAM 303 is used as a work area for the CPU 301. The NVRAM 304 stores various data such as a program and retains the data even when the power of the liquid discharge apparatus 103A is turned off. The external device I/F 308 is connected to a personal computer (PC) via, for example, a universal serial bus (USB) cable to communicate control signals or data to be printed with the PC. The network I/F 309 is an interface circuit that controls communication of data through a communication network such as the Internet. The bus line 310 is, for example, an address bus or a data bus, which electrically connects the components or elements such as the CPU 301 to each other.

The medium conveyor 311 is, for example, a roller and a motor that drives the roller, and conveys an output medium in the sub-scanning direction along the conveyance path in the liquid discharge apparatus 103A. The sub-scanning driver 312 controls the movement of the medium conveyor 311 in the sub-scanning direction. The main scanning driver 313 controls the movement of the carriage 320 in the main scanning direction.

The liquid discharge head 321 of the carriage 320 includes a plurality of nozzles to discharge liquid such as ink. The liquid discharge head 321 is mounted on the carriage 320 such that a discharge face (i.e., a nozzle face) of the liquid discharge head 321 faces the output medium. While moving in the main scanning direction, the liquid discharge head 321 discharges the liquid onto the output medium conveyed intermittently in the sub-scanning direction. Specifically, the liquid discharge head 321 discharges the liquid onto a predetermined position of the output medium, thus an image is formed on the output medium. The liquid discharge head driver 322 is a driver to control the driving of the liquid discharge head 321.

The operation panel 330 includes, for example, a touch panel and one or more alarm lamps. The touch panel displays current settings or a selection screen, and receives user input.

The liquid discharge head driver 322 may be configured not to be mounted on the carriage 320 but to be connected to the bus line outside the carriage 320. Each of the main scanning driver 313, the sub-scanning driver 312, and the liquid discharge head driver 322 may serve as a function implemented by an instruction of the CPU 301 according to a program.

FIG. 3B is a block diagram illustrating another hardware configuration of the image forming apparatus 103 according to the embodiment of the present disclosure. In FIG. 3B, a hardware configuration in the case where the image forming apparatus 103 is an electrophotographic apparatus 103B is illustrated.

As illustrated in FIG. 3B, the electrophotographic apparatus 103B includes a controller 910, a short-range communication circuit 920, an engine controller 930, an operation panel 940, and a network I/F 950.

The controller 910 includes a CPU 901 as a main processor, a system memory 902, a north bridge (NB) 903, a south bridge (SB) 904, an application-specific integrated circuit (ASIC) 906, a local memory 907 as a storage area, a hard disk drive (HDD) controller 908, and a hard disk (HD) 909 as a storage area. The NB 903 and the ASIC 906 are connected via an accelerated graphics port (AGP) bus 921.

The CPU 901 is a processor that controls the entire operation of the electrophotographic apparatus 103B. The NB 903 is a bridge for connecting the CPU 901 with the system memory 902, the SB 904, and the AGP bus 921. The NB 903 includes a memory controller for controlling the reading and writing of various data from and to the system memory 902, a peripheral component interconnect (PCI) master, and an AGP target.

The system memory 902 includes a ROM 902a and a RAM 902b. The ROM 902a stores programs and data for implementing various functions of the controller 910. The RAM 902b is used to load the programs and the data. The RAM 902b is used as, for example, a drawing memory to store drawing data for printing. For the distribution, the programs stored in the ROM 902a may be stored in any computer-readable recording medium, such as a compact disc-read only memory (CD-ROM), compact disc-recordable (CD-R), or digital versatile disc (DVD), in a file format installable or executable by a computer.

The SB 904a is a bridge for connecting the NB 903 to PCI devices and peripheral devices. The ASIC 906 is an integrated circuit (IC) dedicated to image processing and includes hardware elements for image processing. The ASIC 906 serves as a bridge to connect the AGP bus 921, a PCI bus 922, the HDD controller 908, and the local memory 907 to each other. The ASIC 906 includes a PCI target, an AGP master, an arbiter (ARB) as a central processor of the ASIC 906, a memory controller to control the local memory 907, a plurality of direct memory access controllers (DMACs), and a PCI unit. For example, the DMACs convert coordinates of image data with hardware logic to rotate an image based on the image data. The PCI unit transfers data between a scanner engine 931 and a printer engine 932 through the PCI bus 922. To the ASIC 906, a USB interface, the Institute of Electrical and Electronics Engineers 1394 (IEEE1394) interface, or both may be connected.

The local memory 907 is a memory used as a buffer for image data to be copied or a code buffer. The HD 909 is a storage that stores image data, font data for printing, and form data. The HDD controller 908 controls the reading and writing of data from and to the HD 909 under the control of the CPU 901. The AGP bus 921 is a bus interface for a graphics accelerator card, which has been proposed to accelerate graphics processing. The AGP bus 921 directly accesses the system memory 902 with high throughput to accelerate the graphics accelerator card.

The short-range communication circuit 920 is provided with an antenna 920a. The short-range communication circuit 920 is a communication circuit in compliance with, for example, the near field communication (NFC) or BLUETOOTH.

The engine controller 930 includes the printer engine 932. The engine controller 930 may include the scanner engine 931. The operation panel 940 includes a display panel 940a and a hard keypad 940b. The display panel 940a is, for example, a touch panel that displays current settings or a selection screen and receives user input. The hard keypad 940b includes, for example, a numeric keypad and a start key. The numeric keypad receives assigned values of image forming parameters such as an image density parameter. The start key receives an instruction to start copying, for example. The controller 910 controls the entire operation of the electrophotographic apparatus 103B. For example, the controller 910 controls drawing, communication, and input through the operation panel 940. The printer engine 932 or the scanner engine 931 includes an image processor to perform, for example, error diffusion and gamma conversion.

The electrophotographic apparatus 103B may switch among various functions such as setting, color adjustment, and schedule management of printing and maintenance in addition to the printing function by using an application switch key of the operation panel 940. Additionally or alternatively, a document box function, a copying function, and a facsimile communication function may be sequentially switched for selection. The network I/F 950 is an interface circuit that controls communication of data through a communication network. The short-range communication circuit 920 and the network I/F 950 are electrically connected to the ASIC 906 via the PCI bus 922.

FIG. 4 is a block diagram illustrating a hardware configuration of the management server 104 according to the embodiment of the present disclosure. The management server 104 according to the present embodiment is implemented by a computer and includes a CPU 501, a ROM 502, a RAM 503, an HD 504, an HDD controller 505, a display 506, an external device I/F 508, a network I/F 509, a data bus 510, a keyboard 511, a pointing device 512, a digital versatile disc-rewritable (DVD-RW) drive 514, and a medium I/F 516.

The CPU 501 controls the entire operation of the management server 104. The ROM 502 stores a program such as an IPL to boot the CPU 501. The RAM 503 is used as a work area for the CPU 501. The HD 504 stores various data such as a program. The HDD controller 505 controls the reading and writing of data from and to the HD 504 under the control of the CPU 501. The display 506 displays various information such as a cursor, a menu, a window, characters, and images. The external device I/F 508 is an interface circuit that controls communication of data with various external devices. Examples of the external devices in this case include, but are not limited to, a USB memory and a printer. The network I/F 509 is an interface circuit that controls communication of data through a communication network. The data bus 510 is, for example, an address bus or a data bus, which electrically connects the components or elements such as the CPU 501 illustrated in FIG. 4 to each other.

The keyboard 511 serves as an input device provided with a plurality of keys used for, for example, inputting characters, numerical values, and various instructions. The pointing device 512 serves as an input device used for, for example, selecting or executing various instructions, selecting an object to be processed, and moving a cursor being displayed. The DVD-RW drive 514 controls the reading and writing of various data from and to a DVD-RW 513, which serves as a removable recording medium according to the present embodiment. The removable recording medium is not limited to a DVD-RW and may be, for example, a digital versatile disc-recordable (DVD-R). The medium I/F 516 controls the reading and writing (storing) of data from and to a recording medium 515 such as a flash memory.

The hardware configurations of the client PC 101 and the DFE 102 according to the present embodiment may be substantially the same as the hardware configuration of the management server 104, and therefore, the description thereof is omitted.

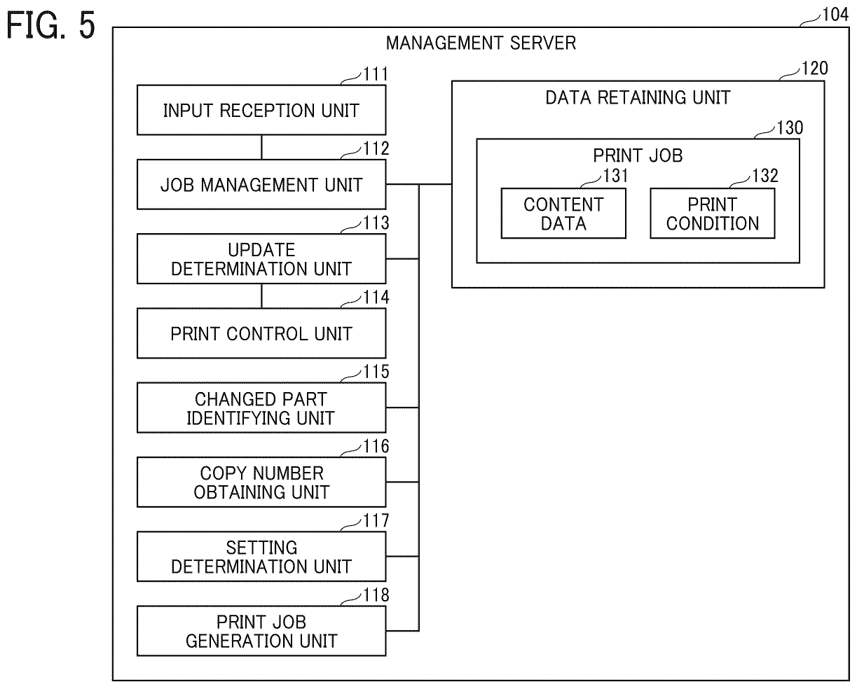

Next, with reference to FIG. 5, the functions of the management server 104 according to the present embodiment are described. FIG. 5 is a block diagram illustrating a functional configuration of the management server 104 according to the embodiment of the present disclosure.

The management server 104 according to the present embodiment includes an input reception unit 111, a job management unit 112, an update determination unit 113, a print control unit 114, a changed part identifying unit 115, a copy number obtaining unit 116, a setting determination unit 117, and a print job generation unit 118. These functional units provide functions implemented by the CPU 501 of the management server 104 executing instructions included in one or more programs installed in, for example, the HD 504.

The management server 104 also includes a data retaining unit 120. The data retaining unit 120 may be implemented by, for example, the HD 504.

The input reception unit 111 according to the present embodiment receives various inputs to the management server 104. Specifically, the input reception unit 111 receives a print job transmitted from the client PC 101.

The job management unit 112 causes the data retaining unit 120 to retain the print job received by the input reception unit 111. Further, the job management unit 112 transmits the print job retained by the data retaining unit 120 to the DFE 102, and causes the image forming apparatus 103 to print the content data included in the print job according to the printing conditions.

The update determination unit 113 determines whether another print job received by the input reception unit 111 is an updated version of the print job stored in the data retaining unit 120.

The print control unit 114 controls the stop and restart of printing executed by the image forming apparatus 103. In addition, the print control unit 114 determines whether a replacement printed matter and separators are required to be printed. Furthermore, the print control unit 114 calculates an index value that serves as an index for determining whether the replacement printed matter is required to be printed. The details of the index value will be described later.

The changed part identifying unit 115 identifies a changed (updated) part when the other print job received by the input reception unit 111 is an updated version of the print job retained in the data retaining unit 120. In the present embodiment, the content data included in the print job may be changed, or the printing conditions may be changed.

The copy number obtaining unit 116 obtains the number of copies of the printed matter that have already been printed and the number of copies of the printed matter that have not yet been printed out of the number of copies to be printed set as a printing condition. In the following description, the number of copies of the printed matter that have already been printed is referred to as the number of printed copies, and the number of copies of the printed matter that have not yet been printed is referred to as the number of remaining copies.

The setting determination unit 117 determines whether the index value that serves as an index for determining whether a replacement printed matter is required to be printed for replacing a printed matter already printed is set.

The print job generation unit 118 generates a print job for causing the image forming apparatus 103 to print a replacement printed matter or separators.

In the data retaining unit 120, a print job received by the input reception unit 111 is retained. In FIG. 5, a print job 130 is retained in the data retaining unit 120. The print job 130 includes content data 131 and a printing condition (a set of printing conditions) 132.

The print job retained in the data retaining unit 120 may be deleted after the print job is executed, or may be retained for a certain period of time after the print job is executed and then deleted.

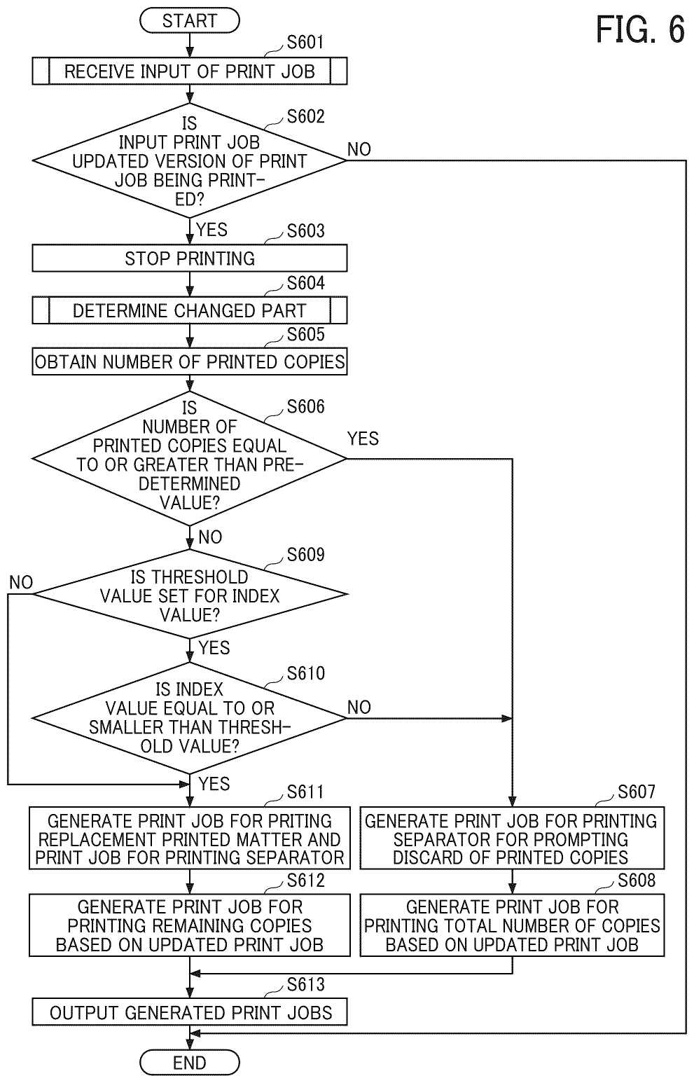

Next, with reference to FIG. 6, the functions of the management server 104 according to the present embodiment are described. FIG. 6 is the first flowchart of the processing executed by the management server 104 according to the embodiment of the present disclosure.

The input reception unit 111 of the management server 104 according to the present embodiment receives an input of a print job (step S601).

The update determination unit 113 of the management server 104 determines whether the print job received in step S601 is an updated version of a print job being executed (a print job being printed) by the image forming apparatus 103 (step S602). The details of the processed of steps S601 and S602 will be described later.

In step S602, when the print job received in step S601 is determined not to be an updated version of the print job being printed (NO in step S602), the printing is continued without any other process.

In step S602, when the print job received in step S601 is determined to be an updated version of the print job being printed (YES in step S602), the print control unit 114 of the management server 104 stops the printing being executed by the image forming apparatus 103 (step S603).

The changed part identifying unit 115 of the management server 104 determines a changed part between the print job before the update and the print job after the update (step S604). The details of the process of step S604 will be described later.

The copy number obtaining unit 116 of the management server 104 obtains the number of printed copies, which is the number of copies of the print job before the update that have already been printed (step S605).

The print control unit 114 of the management server 104 determines whether the number of printed copies is equal to or greater than a predetermined value set for the number of printed copies (step S606).

The predetermined value in the present embodiment is a value referred to when determining whether to discard all the printed copies of the printed matter of the print job before the update and print the print job after the update by all the number of copies to be printed set as a printing condition. The predetermined value of the present embodiment may be set in advance by, for example, the operator or an administrator and held in the print control unit 114.

The predetermined value in the present embodiment may be, for example, a value indicating a particular ratio to the number of copies to be printed set as the printing condition. The predetermined value in the present embodiment may be held in the print control unit 114 as, for example, “a value that is 90% of the number of copies to be printed set as a printing condition.”

In the case where the number of printed copies is determined to be equal to or greater than the predetermined value in step S606 (YES in step S606), the print job generation unit 118 of the management server 104 generates a print job for printing a separator for prompting the discard of the printed copies (step S607). Specifically, the print job generation unit 118 generates the print job so that information instructing the discard of the printed copies of the printed matter is printed on the separator.

The print job generation unit 118 of the management server 104 generates a print job for causing the image forming apparatus 103 to print the print job after the update received in step S601 by the number of copies to be printed set as the printing condition (step S608). Then, the processing proceeds to step S613 to be described later.

In the present embodiment, the predetermined value is set as described above. Accordingly, when the printing of the majority of the number of copies to be printed set as the printing condition is completed before the print job is updated, the work for replacing the changed part can be omitted and reprinting can be executed using the print job after the update.

In the case where the number of printed copies is determined to be smaller than the predetermined value in step S606 (NO in step S606), the setting determination unit 117 of the management server 104 determines whether a threshold value is set by the operator for the index value referred to when it is determined whether the work for replacement is required to be performed (step S609).

The index value in the present embodiment is a value indicating the degree of the work load for replacing the printed matter obtained by executing the print job before the update.

The index value in the present embodiment may be a value obtained based on the ratio of the number of printed copies to the number of copies to be printed set as a printing condition and the ratio of the number of pages of a printed matter used for replacement to the number of pages of a printed matter when one copy of content data before an update is printed.

In the following explanation, the ratio of the number of printed copies to the number of copies to be printed set as a printing condition is referred to as the first ratio. The ratio of the number of sheets of the printed matter used for replacement to the number of sheets of the printed matter when one copy of the content data before the update is printed is referred to as the second ratio.

The number of sheets of the printed matter when one copy of the content data before the update is printed corresponds to the number of pages included in the content data before the update. The number of sheets of the printed matter used for replacement corresponds to the number of pages whose contents are changed when the content data is updated.

Specifically, the index value in the present embodiment may be calculated as a value obtained by multiplying the first ratio by the second ratio.

In the present embodiment, the index value is calculated as described above. For example, even when the number of printed copies is small but the number of sheets used for replacement in one copy is large, the index value becomes a value indicating that the work load for the replacement is heavy. By contrast, even when the number of printed copies is large but the number of sheets used for replacement in one copy is small, the index value becomes a value indicating that the work load for the replacement is not so heavy.

In the case where a threshold value for the index value is determined not to be set in step S609 (NO in step S609), the processing executed by the management server 104 proceeds to step S611 to be described later.

In the case where a threshold value for the index value is determined to be set in step S609 (YES in S609), the print control unit 114 of the management server 104 calculates the index value and determines whether the index value is equal to or smaller than the threshold value (step S610).

The index value is calculated based on the number of copies to be printed included in the printing conditions, the number of printed copies, the number of pages of the content data included in the print job being printed, and the number of pages whose contents are changed due to the update among the pages of the content data included in the print job being printed.

The threshold value in the present embodiment may be held by the setting determination unit 117. In the following description, the number of pages whose contents are changed due to the update among the pages of the content data included in the print job being printed is referred to as the number of changed pages.

In the case where the index value is determined to be greater than the threshold value in step S610 (NO in step S610), the processing executed by the management server 104 proceeds to step S607. The case where the index value is greater than the threshold value is a case where the work load for the replacement is heavy for the operator and it is considered that reprinting the print job after the update is more efficient than performing the work for the replacement.

In the case where the index value is determined to be equal to or smaller than the threshold value in step S610 (YES in step S610), the print job generation unit 118 of the management server 104 generates a print job for printing a replacement printed matter by the number of printed copies and print jobs for printing separators immediately before and after printing the replacement printed matter (step S611).

The case where the index value is equal to or smaller than the threshold value is a case where the work load for the replacement is not so heavy and it is considered that performing the work for replacing the changed part is more efficient than reprinting the print job after the update.

The print job generation unit 118 of the management server 104 generates a print job for printing the content data included in the print job after the update by the number of remaining copies (step S612).

The print control unit 114 of the management server 104 outputs the print jobs generated by the print job generation unit 118 to the DFE 102 (step S613).

As described above, according to the present embodiment, when a print job is updated during being printing, a replacement printed matter and a printed matter of the print job after the update are automatically printed in succession.

In the case of FIG. 6, the index value is referred to to determine whether to perform the work for the replacement, but the reference is not limited thereto. In the present embodiment, for example, a threshold value may be set for the number of printed copies or the number of changed pages. In this case, for example, when each of the number of printed copies and the number of changed pages is determined to be equal to or greater than the threshold value set for each, reprinting may be executed without the work for the replacement being performed. Alternatively, for example, when the number of changed pages is determined to be equal to or greater than the threshold value, reprinting may be executed regardless of the number of printed copies. These settings may be operated by the operator as desired.

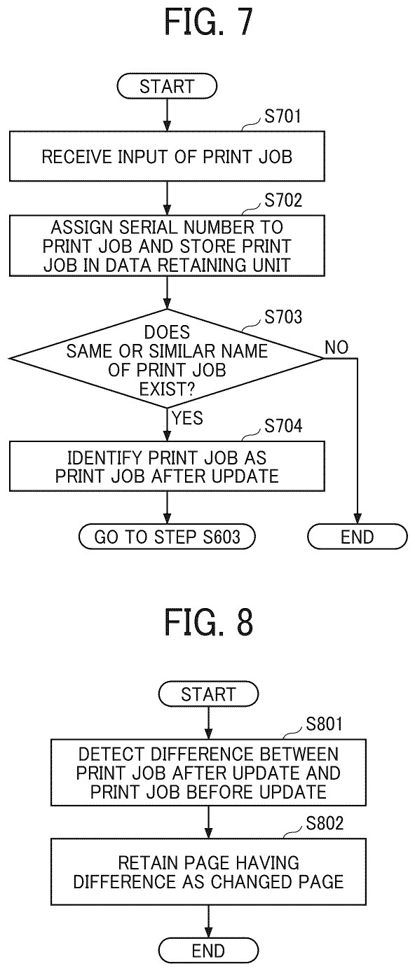

Next, with reference to FIG. 7, the processes executed by the job management unit 112 and the update determination unit 113 according to the present embodiment are described. FIG. 7 is the second flowchart of the processing executed by the management server 104 according to the embodiment of the present disclosure. With reference to FIG. 7, the details of the processes in steps S601 and S602 of FIG. 6 are described. More specifically, in the management server 104 according to the present embodiment, when the input reception unit 111 receives an input of a print job from the client PC 101 (step S701), the job management unit 112 assigns a serial number to the received print job for identifying the print job and stores the received print job in the data retaining unit 120 (step S702). The processes up to this point correspond to the process in step S601 of FIG. 6.

The update determination unit 113 of the management server 104 determines whether the file name of the print job received in step S701 is the same as or similar to the file name of the print job 130 retained in the data retaining unit 120 (step S703).

The update determination unit 113 in the present embodiment may determine that two file names are similar to each other when a predetermined number or more of characters included in the two file names match each other.

In the case where the file name of the print job received in step S701 and the file name of the print job 130 retained in the data retaining unit 120 in step S703 are determined to be the same or similar to each other (YES in S703), the update determination unit 113 identifies the print job received in step S701 as the print job after the update of the print job 130 (step S704). Then, the processing proceeds to step S603 in FIG. 6.

In step S703, in the case where a print job whose file name is determined to be the same as or similar to the file name of the print job received in step S701 is not retained in the data retaining unit 120 (NO in step S703), the update determination unit 113 determines that the input print job is a new print job. Then, the processing ends. The processes in step S703 and S704 of FIG. 7 correspond to the process in step S602 of FIG. 6.

Next, with reference to FIG. 8, the processes executed by the changed part identifying unit 115 of the management server 104 are described. FIG. 8 is the third flowchart of the processing executed by the management server 104 according to the embodiment of the present disclosure. With reference to FIG. 8, the details of the process in step S604 of FIG. 6 are described.

In the management server 104 according to the present embodiment, the changed part identifying unit 115 detects a difference between the print job after the update identified in step S704 of FIG. 7 and the print job before the update (step S801).

The difference in the present embodiment refers to a difference in the content data included in the print jobs. Accordingly, the changed part identifying unit 115 detects, as a difference, one or more pages whose contents are changed in the content data included in the print job after the update from the content data included in the print job before the update. The print job before the update may be a print job waiting to be printed.

The changed part identifying unit 115 holds, as changed pages, the one or more pages on which the difference from the content data included in the print job before the update is detected (step S802).

In the present embodiment, as described above, the number of changed pages can be obtained by holding the one or more pages whose contents are changed due to the update in the print job before the update.

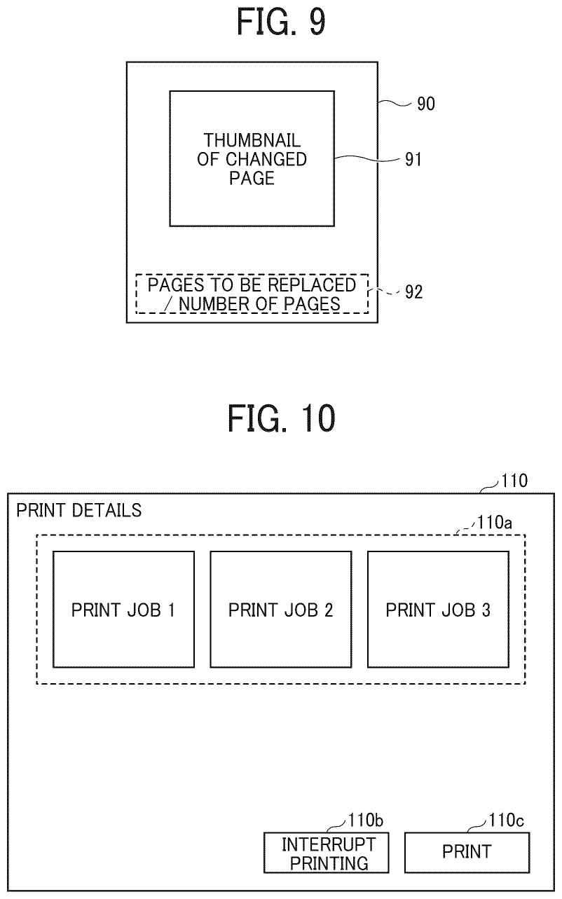

Next, with reference to FIG. 9, a separator according to the present embodiment is described. FIG. 9 is a diagram illustrating an example of a separator according to the embodiment of the present disclosure.

A separator 90 illustrated in FIG. 9 may be, for example, an example of the separator 22 printed immediately before the replacement printed matter 21A.

The separator 90 may include a thumbnail image 91 indicating one or more changed pages. In this way, in the work for the replacement, the operator can visually grasp the pages to be replaced in the printed matter that has already been printed.

In addition, the separator 90 may include information 92 indicating the pages to be replaced with the replacement printed matter 21A in the printed matter that has already been printed and the number of pages to be replaced.

For example, it is assumed that the number of pages of one copy of a printed matter printed based on a print job before an update is 100 and pages 20 to 30 are to be replaced out of the 100 pages.

In this case, information indicating “20 to 30” as the pages to be replaced and “11” as the number of pages to be replaced may be printed on the separator 90.

When the replacement printed matter includes multiple pages as described above, the separator may be printed each time one copy of the replacement printed matter is printed. For example, when 10 copies of a printed matter already exist, 10 copies of a replacement printed matter are also printed. In this case, in the present embodiment, by printing a separator each time one copy of the replacement printed matter is printed, the replacement printed matter is easily taken out one copy at a time.

Alternatively, in the present embodiment, the printed matters may be ejected alternately in the vertical and horizontal directions, instead of printing the separator.

Specifically, for example, the management server 104 may cause the image forming apparatus 103 to eject the printed matters so that the long edge (i.e., in the vertical direction) of the printed matter printed based on the print job before the update and the short edge (i.e., in the horizontal direction) of the replacement printed matter intersect each other. Alternatively, the management server 104 may cause the image forming apparatus 103 to eject the printed matters so that the short edge (i.e., in the horizontal direction) of the replacement printed matter and the long edge (i.e., in the vertical direction) of the printed matter printed based on the print job after the update intersect each other.

In this way, when the work for the replacement is performed, the replacement printed matter is easily taken out from the finisher.

In the printing system 100 according to the present embodiment, the image forming apparatus 103 is caused to stop printing of a print job before an update being executed, and execute another print job until the print job after the update is input. In the following description, the operation of interrupting the execution of a print job and causing another print job to be executed as described above is referred to as interrupt printing. The interrupt printing according to the present embodiment is executed in response to receiving a request for interruption operated by the operator of the printing system 100.

FIG. 10 is a diagram illustrating display of a screen for requesting an interruption according to the embodiment of the present disclosure. A screen 110 illustrated in FIG. 10 is displayed on the display 506 of the management server 104, for example, in response to an operation operated by the operator for the interrupt printing.

The screen 110 includes a display field 110a, an operation button 110b, and an operation button 110c. In the display field 110a, a list of print jobs retained in the data retaining unit 120 may be displayed.

The operation button 110b may be an operation button for stopping (interrupting) the printing of the image forming apparatus 103. The operation button 110c may be an operation button for executing a print job selected from the list of print jobs displayed in the display field 110a.

In the present embodiment, the printing executed by the image forming apparatus 103 based on a print job being printed can be manually stopped as described above. Accordingly, for example, when it is determined that the print job being printed is to be updated, the printing executed by the image forming apparatus 103 can be stopped, and another print job can be executed until the print job is updated.

As a result, according to the present embodiment, the time during which the printing executed by the image forming apparatus 103 is interrupted is shortened.

Each of the functions described above in the embodiments of the present disclosure may be implemented by one processing circuit or a plurality of processing circuits. The “processing circuit or circuitry” herein includes a programmed processor to execute each function by software, such as a processor implemented by an electronic circuit, and devices, such as an application specific integrated circuit (ASIC), a digital signal processor (DSP), a field programmable gate array (FPGA), and circuit modules known in the art arranged to perform the recited functions.

The group of apparatuses or devices described in the above-described embodiments of the present disclosure are merely one example of a plurality of computing environments that implement embodiments of the present disclosure.

In some embodiments, the management server 104 includes multiple computing devices such as a server cluster. The multiple computing devices communicate with one another through any type of communication link including, for example, a network or a shared memory, and perform the operations disclosed herein. Similarly, the management server 104 may include a plurality of computing devices configured to communicate with one another.

Further, the management server 104 may be configured to share the disclosed processing steps in various combinations. For example, processing executed by one or more particular units may be executed by a plurality of information processing apparatuses included in the management server 104. Similarly, the functions executed by one or more particular units may be performed by the management server 104. Further, the components of the management server 104 may be integrated into one apparatus or may be divided into multiple apparatuses.

The management server 104 can be any device having a communication function. Examples of the management server 104 include a projector, an output device such as digital signage, a head-up display (HUD) apparatus, an industrial machine, an image-capturing device, a sound collecting device, a medical device, a networked home appliance, a connected car, a laptop PC, a mobile phone, a smartphone, a tablet communication terminal, a game console, a personal digital assistant (PDA), a digital camera, a wearable PC, and a desktop PC.

Aspects of the present disclosure are, for example, as follows.

### Aspect 1

According to Aspect 1, a printing system includes an image forming apparatus and a print control apparatus. The print control apparatus includes a changed part identifying unit and a print control unit. The changed part identifying unit identifies, from first content data input to the print control apparatus, one or more pages whose contents are changed from second content data being printed by the image forming apparatus. The print control unit causes the image forming apparatus to print the one or more pages whose contents are changed by the number of printed copies of the second content data and the first content data by the number of remaining copies out of the number of copies to be printed set for the second content data.

### Aspect 2

According to Aspect 2, in the printing system according to Aspect 1, the print control unit causes the image forming apparatus to print a first separator immediately before printing the one or more pages whose contents are changed and print a second separator immediately after printing the one or more pages whose contents are changed. The first separator indicates that the printed matter to be printed next is a printed matter for replacing a printed matter of the second content data. The second separator indicates that the printed matter to be printed next is another printed matter of the first content data.

### Aspect 3

According to Aspect 3, in the printing system according to Aspect 1 or 2, the print control unit determines whether the number of printed copies of the second content data is equal to or greater than a predetermined ratio to the number of copies to be printed set for the second content data. In the case where the number of printed copies is equal to or greater than the predetermined ratio, the print control unit causes the image forming apparatus to print a separator for prompting discard of the printed matter of the second content data and the first content data by the number of printed copies of the second data.

### Aspect 4

According to Aspect 4, in the printing system according to any one of Aspects 1 to 3, the print control unit determines whether to cause the image forming apparatus to print the one or more pages whose contents are changed, in accordance with an index value indicating a degree of work load for replacing the one or more pages whose contents are changed.

### Aspect 5

According to Aspect 5, in the printing system according to Aspect 4, the print control unit causes the image forming apparatus to print the first content data by the number of printed copies of the second content data in the case where the index value is greater than a threshold value, and causes the image forming apparatus to print the one or more pages whose contents are changed by the number of printed copies of the second content data and the first content data by the number of remaining copies in the case where the index value is equal to or smaller than the threshold value.

### Aspect 6

According to Aspect 6, in the printing system according to Aspect 4 or 5, the index value is calculated based on a ratio of the number of printed copies of the second content data to the number of copies to be printed set as a printing condition for the second content data and a ratio of the number of pages whose contents are changed to the number of pages of the printed matter when one copy of the second content data is printed.

### Aspect 7

According to Aspect 7, a print control apparatus for controlling printing executed by an image forming apparatus includes a changed part identifying unit and a print control unit. The changed part identifying unit identifies, from first content data input to the print control apparatus, one or more pages whose contents are changed from second content data being printed by the image forming apparatus. The print control unit causes the image forming apparatus to print the one or more pages whose contents are changed by the number of printed copies of the second content data and the first content data by the number of remaining copies out of the number of copies to be printed set for the second content data.

### Aspect 8

According to Aspect 8, a print control method performed by a printing system including an image forming apparatus and a print control apparatus. The method includes identifying, from first content data input to the print control apparatus, one or more pages whose contents are changed from second content data being printed by the image forming apparatus and causing the image forming apparatus to print the one or more pages whose contents are changed by the number of printed copies of the second content data and the first content data by the number of remaining copies out of the number of copies to be printed set for the second content data.

### Aspect 9

According to Aspect 9, a print control method performed by a print control apparatus that controls printing executed by an image forming apparatus. The method includes identifying, from first content data input to the print control apparatus, one or more pages whose contents are changed from second content data being printed by the image forming apparatus and causing the image forming apparatus to print the one or more pages whose contents are changed by the number of printed copies of the second content data and the first content data by the number of remaining copies out of the number of copies to be printed set for the second content data.

### Aspect 10

According to Aspect 10, a non-transitory recording medium storing a plurality of program codes which, when executed by one or more processors, causes the one or more processors to perform a method. The method includes identifying, from first content data input to a print control apparatus, one or more pages whose contents are changed from second content data being printed by an image forming apparatus and causing the image forming apparatus to print the one or more pages whose contents are changed by the number of printed copies of the second content data and the first content data by the number of remaining copies out of the number of copies to be printed set for the second content data.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A printing system comprising:
an image forming apparatus; and
a print control apparatus including circuitry configured to:
identify, from among a plurality of pages of first content data input to the print control apparatus, one or more pages having contents that are changed from second content data, the second content data being printed by the image forming apparatus; and
cause the image forming apparatus to print the one or more pages having the changed contents by a number of printed copies of the second content data, and the first content data by a number of remaining copies out of a number of copies to be printed set for the second content data.

2. The printing system according to claim 1, wherein:
the circuitry is configured to cause the image forming apparatus to print a first separator immediately before printing the one or more pages having the changed contents and print a second separator immediately after printing the one or more pages having the changed contents;
the first separator indicates that a printed matter to be printed subsequent to the first separator is a printed matter for replacing a printed matter obtained by printing the second content data; and
the second separator indicates that a printed matter to be printed subsequent to the second separator is another printed matter obtained by printing the first content data.

3. The printing system according to claim 1, wherein the circuitry is further configured to:
determine whether a ratio of the number of printed copies of the second content data to the number of copies to be printed set for the second content data is equal to or greater than a predetermined ratio; and
in a case that the ratio of the number of printed copies to the number of copies to be printed is equal to or greater than the predetermined ratio, cause the image forming apparatus to print a separator for prompting discard of a printed matter of the second content data and the first content data by the number of printed copies of the second content data.

4. The printing system according to claim 1, wherein the circuitry is further configured to determine whether to cause the image forming apparatus to print the one or more pages having the changed contents, in accordance with an index value indicating a degree of work load for replacing the one or more pages having the changed contents.

5. The printing system according to claim 4, wherein the circuitry is configured to:
in a case that the index value is greater than a threshold value, cause the image forming apparatus to print the first content data by the number of printed copies of the second content data; and
in a case that the index value is equal to or smaller than the threshold value, cause the image forming apparatus to print the one or more pages having the changed contents by the number of printed copies of the second content data and the first content data by the number of remaining copies.

6. The printing system according to claim 4, wherein the circuitry is configured to calculate the index value based on a ratio of the number of printed copies of the second content data to the number of copies to be printed set as a printing condition for the second content data, and a ratio of a number of pages having the changed contents to a number of pages of a printed matter obtained by printing one copy of the second content data.

7. A print control apparatus for controlling printing executed by an image forming apparatus, the print control apparatus comprising circuitry configured to:
identify, from among a plurality of pages of first content data input to the print control apparatus, one or more pages having contents that are changed from second content data, the second content data being printed by the image forming apparatus; and
cause the image forming apparatus to print the one or more pages having the changed contents by a number of printed copies of the second content data, and the first content data by a number of remaining copies out of a number of copies to be printed set for the second content data.

8. A print control method performed by a print control apparatus, the method comprising:
identifying, from among a plurality of pages of first content data input to the print control apparatus, one or more pages having contents that are changed from second content data, the second content data being printed by an image forming apparatus; and
causing the image forming apparatus to print the one or more pages having the changed contents by a number of printed copies of the second content data, and the first content data by a number of remaining copies out of a number of copies to be printed set for the second content data.

9. A non-transitory recording medium storing a plurality of program codes which, when executed by one or more processors of a print control apparatus, causes the one or more processors to perform a print control method comprising:
identifying, from among a plurality of pages of first content data input to the print control apparatus, one or more pages having contents that are changed from second content data, the second content data being printed by an image forming apparatus; and
causing the image forming apparatus to print the one or more pages having the changed contents by a number of printed copies of the second content data, and the first content data by a number of remaining copies out of a number of copies to be printed set for the second content data.
